(19) United States
(12) Patent Application Publication
(10) Pub. No.: US 2018/0346095 A1
(43) Pub. Date: Dec. 6, 2018

(54) FOAM AEROFOIL

(71) Applicant: Andrew Charles Elson, Maesbury (GB)

(72) Inventor: Andrew Charles Elson, Maesbury (GB)

(21) Appl. No.: 15/761,706

(22) PCT Filed: Sep. 19, 2016
(86) PCT No.: PCT/GB2016/052917

§ 371 Date: Mar. 20, 2018

(30) Foreign Application Priority Data
Sep. 21, 2015 (GB) 1516712.5

(51) Int. Cl. B64C 3/22; B64C 39/02; B64C 3/26; B64C 3/18; B64F 5/10

(52) U.S. Cl. CPC B64C 3/22; B64C 39/024; B64C 3/26; B64C 3/185; B64C 3/187; B64C 2201/066; B64C 2201/021; B64C 2201/042; B64C 2201/104; B64C 2201/165; B64F 5/10

(57) ABSTRACT

An aerofoil has at least one space frame and at least one pre-stressed cover supported by the space frame. The space frame has one or more structural members, the structural members including a structural foam material; and the pre-stressed cover forms at least a part of an external aerodynamic surface of the aerofoil.

### FIELD OF THE INVENTION

The present invention relates to a structural foam aerofoil, to a method of manufacturing said aerofoil and also to an unmanned aerial vehicle including the aerofoil of the invention.

### BACKGROUND OF THE INVENTION

Flight at stratospheric altitudes has the advantage that the stratosphere exhibits very stable atmospheric conditions, with wind strengths and turbulence levels at a minimum between altitudes of approximately 18 to 30 kilometres. The deployment of an unmanned aerial vehicle (UAV) capable of long duration flights in the stratosphere allows large areas of the planet to be observed, with the distance to the horizon being over 500 km for much of the optimum altitude range. Such UAVs are therefore suitable for aerial surveys, as well as intelligence, surveillance and reconnaissance missions, and communications relay operations.

In 2002 the present inventor and QinetiQ built the Zephyr aircraft (Zephyr III), in order to film a balloon altitude record attempt at 40,000 metres. In 2007, QinetiQ flew the Zephyr for 83 hours, and in 2008 Zephyr reached a record altitude of 29,000 metres, carrying a payload of around 2.5 kilograms. The Zephyr currently holds the official endurance record for a UAV for a flight in July 2010 lasting 336 hours and 22 minutes (14 days and 22 minutes).

Whilst weight is a key issue for any aircraft designer, it is critical for a UAV optimised for extreme duration flight, and central to the consideration of the wing design.

A known aerofoil structure is described in U.S. Pat. No. 3,416,756 in which the body of the aerofoil is made of structurally rigid foamed material. The outer surfaces of the aerofoil have an array of spaced apart longitudinally disposed slots therein which each contain a spar element. Each slot is closed by a plug of structurally rigid foamed material, and the spar elements are bonded both to the slots and to the plugs. The aerofoil body is covered by a skin which is bonded to the body.

### SUMMARY OF THE INVENTION

At its most general, the invention provides a lightweight aerofoil comprising a space frame having structural component(s) comprising a structural foam material.

A first aspect of the invention provides an aerofoil comprising at least one space frame and at least one cover supported by the space frame, wherein the space frame has one or more structural members, the structural members including a structural foam material; and the cover includes a pre-stressed membrane which forms at least a part of an external aerodynamic surface of the aerofoil.

A second aspect of the invention provides a method of producing an aerofoil comprising at least one space frame and at least one cover supported by the space frame comprising the steps of:

forming a space frame comprising one or more structural members, the structural members including a structural foam material;
pre-stressing and attaching a membrane, which forms at least part of the cover, to the space frame.

A third aspect of the invention provides an unmanned aerial vehicle comprising the aerofoil. The unmanned aerial vehicle may comprise at least two wings, a fuselage, a tail and at least one propeller powered by a motor and a power supply. The unmanned aerial vehicle may have a wingspan of from 20 m to 60 m.

Flying a UAV for long durations in the stratosphere requires an extremely lightweight vehicle that nevertheless should be sufficiently robust, dimensioned and proportioned to carry payload (for example batteries, cameras etc). The lighter the vehicle, the less energy will be required to power the vehicle over the flight duration and therefore the longer the potential flight duration. Cellular foam such as Rohacell is known for use as a core material in a sandwich structure. However, the inventor has made the insight that using this foam as a structural, i.e. loading bearing, component of the aerofoil, enables an extremely lightweight aerofoil to be manufactured.

Pre-stressing the membrane that forms the outer aerodynamic surface of the aerofoil further strengthens the aerofoil, and allows the aerofoil to behave as a monocoque structure. Increasing the torsional and structural rigidity of the aerofoil in this way enables the design of other parts of the aerofoil to be further optimised, for example for minimum weight. Additionally, an enhanced structural rigidity provides the ability of the aerofoil to carry an increased payload.

An unmanned aerial vehicle (UAV), also referred to as an unpiloted aerial vehicle or a remotely piloted aircraft (RPA) by the International Civil Aviation Organization (ICAO), is defined as an aircraft piloted by remote control or onboard computers, i.e. there is no human pilot aboard. A UAV used for military purposes is typically known as a drone. Model aeroplanes are largely flown within visual line of sight and in the presence of an operator who watches and maintains control of the airplane during flight. A UAV is not limited in this way, indeed the UAV of the present invention is designed to fly at an altitude far higher than the visual line of sight.

A space frame is defined as a three-dimensional structural framework which is designed to behave as an integral unit and to withstand loads applied at any point. The frame or framework is the rigid supporting structure of the aerofoil that assists in defining the shape of the aerofoil and, because it surrounds vacant space, is termed a space frame. The space frame may be constructed from interlocking struts or may have the frame structure hollowed out of a block of raw material or be formed via an additive layer manufacturing process, building the framework layer by layer. If manufactured as a single component, the structural members may therefore be integrally connected, or the framework may be considered to have a single structural member. Space frames can be used to span large areas with few interior supports, which thus makes the space frame an effective structure when designing for lightweight applications.

Structural foam material is foam that has been formed via a process of injecting an inert gas (e.g. nitrogen) through a melted polymer to form a foam, which is then moulded. The foam expands in the mould resulting in an outer skin which is denser than the core, and a final moulding that has a lower weight and increased stiffness relative to a standard injection moulded product. The polymer used may be any thermoplastic polymer, commonly used examples are polystyrene, polycarbonate, polyvinylchloride, polypropylene, acrylonitrile-butadiene-styrene (ABS) or a polymethacrylimide (PMI) such as that used in Rohacell™ structural foam. Rohacell™ 31 IG-F has been chosen as an example due to the key properties of the material: it is lightweight, dimensionally stable with temperature and exposure to ultraviolet light, and closed cell and therefore not hygroscopic. Other manufacturers of structural foam include Gurit and Polycel. The structural foam material used in the invention may be a cellular core foam of any of the materials listed above.

The structural member(s) of the aerofoil of the invention may be slotted together without the use of adhesive, fasteners or any other components, such that the structural members may consist of a structural foam material. Alternatively, the structural members may have structural reinforcement or be otherwise fastened together such that the structural members comprise structural foam.

The aerofoil has a leading edge and a trailing edge, and the one or more structural members may have an upper face and a lower face, the aerofoil may have a cover comprising an upper layer including structural foam material and a lower layer including structural foam material. The cover includes a membrane defining the outer aerodynamic surface.

The aerofoil space frame comprises structural members which may be one or more chordwise ribs and one or more longitudinal spars. One or more of the spars may include structural foam material. The one or more spars may be formed in two or more parts and connect with the one or more ribs. One or more of the ribs may include structural foam material. One or more of the ribs and/or spars may be substantially planar. The aerofoil of the invention may comprise a plurality of spars spaced apart in the chordwise direction, the distance between adjacent spars being the spar pitch, wherein the spar pitch may be irregular in the chordwise direction.

One or more joints may be formed between structural members, wherein each structural member may comprise one or more cooperative connecting features such that each joint is formed by connecting the cooperative connecting feature(s) of one structural member with the corresponding cooperative connecting feature(s) of a further structural member. The cooperative connecting feature(s) may take a number of different forms, for example they may be slots such that each joint is formed by interconnecting a slot in one structural member with a corresponding slot in a further structural member. Alternatively, the corresponding cooperative connecting feature(s) may be protrusions and/or recesses such that each joint is formed by interlocking a protrusion in one structural member with a recess in another structural member. The slots, protrusions, recesses or tabs may have straight or curved contoured sides or profiles, and in one option may be shaped much like interlocking planar jigsaw pieces.

The one or more structural members and the cover may comprise at least one cut-out/opening, such that when the space frame and cover are assembled, one or more hollow cells are formed, the hollow cell(s) being bounded by the structural member(s) and including the cut-out(s). One or more of the hollow cells may extend spanwise along the aerofoil and carry payload.

The membrane provides strength and resists the aerofoil bending. Pre-stressing the membrane before attaching the membrane to the aerofoil enables the aerofoil to behave as a monocoque structure, i.e. the membrane becomes a structural component also and increases the loads that can be supported by the aerofoil. The membrane is required to be dimensionally stable with temperature and under UV light conditions, whilst providing good tensile strength to weight ratio. The membrane may in principal be made of any film material, in an embodiment a polyimide film is used, for example Kapton™. The film thickness is a compromise between weight and the above mentioned key material properties, in an embodiment 12.5 micron thickness is used, however 25 micron could equally well be used or a film thinner than 12.5 micron.

Payload relates to items carried by the vehicle which do not contribute directly to the flight of the vehicle, e.g. are not involved in providing lift, structure or propulsion. Payload therefore includes any solar collectors not provided for propulsion, auxiliary batteries and other functional equipment such as cameras, receivers, transmitters, geopositional systems, antennas etc carried by the vehicle.

The method of producing the aerofoil may include the step of assembling at least two structural members. The step of assembling at least two structural members may comprise forming one or more joints between members, wherein each structural member may comprise one or more cooperative connecting features such that each joint may be formed by connecting the cooperative connecting feature(s) of one structural member with the corresponding cooperative connecting feature(s) of a further structural member. Alternatively, the method of producing the aerofoil may include that one or more parts of the space frame are formed, for example by machining, from a one or more blocks of structural foam with structural members formed by removing material from the foam block.

### BRIEF DESCRIPTION OF THE DRAWINGS

Embodiments of the invention will now be described with reference to the accompanying drawings, in which:

FIG. 1 shows an unmanned aerial vehicle at altitude having just been released from attachment to a balloon,

FIG. 2 shows an exploded perspective view of a foam aerofoil according to an embodiment of the invention, excluding the aerodynamic surface membrane,

FIG. 3 shows an enlarged section of the aerofoil of FIG. 2,

FIG. 4 shows a side view of an individual rib,

FIG. 5 shows a side view of an individual upper and lower spar,

FIG. 6 shows a perspective view of the aerofoil with all components except the upper cover assembled, and with the membrane not shown,

FIG. 7 shows a perspective view of the assembled aerofoil including the membrane.

FIG. 8 shows a perspective view of the aerofoil with all components except the upper cover assembled, and with the membrane not shown, the aerofoil comprising additional spars.

FIG. 9a is a side elevation of the aerofoil showing reinforcement for payload,

FIG. 9b is a schematic view of the payload reinforcement installed within the space frame of the aerofoil,

FIG. 10 is a plan view schematic of an alternative cover construction showing interlocking planar tabs and recesses.

FIG. 11 is a schematic perspective view of the space frame showing an alternative arrangement where solar cells of differing shapes are inserted into the space frame to form the cover.

### DETAILED DESCRIPTION OF EMBODIMENT(S)

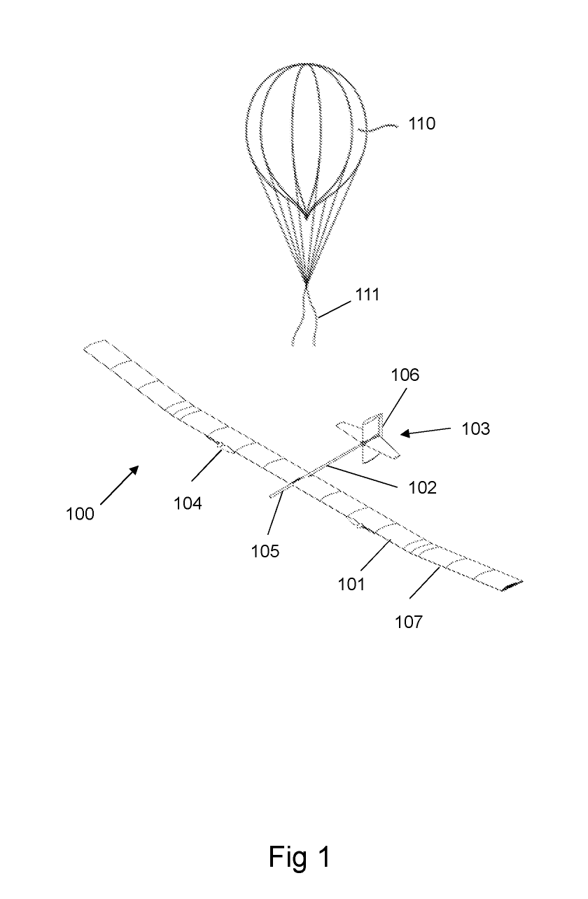

FIG. 1 shows a UAV 100 having two wings 101, a fuselage 102, and a tailplane 103. The UAV is lifted to altitude by a balloon 110 in a wingtip up configuration and then reoriented in readiness for release. FIG. 1 shows the UAV 100 having reached its launch altitude and the tethers 111 attaching the UAV 100 to the balloon 110 having been released. The UAV 100 is released into its flight mode.

In this embodiment the fuselage 102 is a minimal structure, comprising simply a lightweight tube, with the wings 101 and tailplane 103 attached to the tube. The tube is of carbon fibre construction, having a diameter in the range of 60 to 120 mm and a wall section of 0.5 mm. In alternative embodiments, the fuselage may be constructed of any lightweight material, for example wood, plastic or fibre reinforced composite, and may be hollow or solid, and of any shape suitable for having wings and tailplane attached. The shape and dimensions of the fuselage may vary along the length of the fuselage, for example to provide weight balance, and may be elliptical or tapered. The nose 105 of the fuselage extends forwards of the wings and acts to counter balance the weight of the tailplane. The nose 105 also provides optional payload storage.

The tailplane 103 has cruciform vertical and horizontal stabilising surfaces attached to the fuselage 102. The trailing portion of the stabiliser has an active movable rudder 106 located at the upper and lower portion of the vertical stabilising surface. An actuator controls the rudder 106, the actuator being located in the tailplane 103.

The wings 101 are elongate in a spanwise direction with a wingspan of between 20-60 metres, extending either side of the fuselage 102. The wing may be straight or tapered in the outboard direction, and the wings may be horizontal or have a dihedral or an anhedral angle from the point the wing meets the fuselage, or from any point along the wing.

Each of the wings 101 carry a motor driven propeller 104 which may be powered by rechargeable batteries, or the batteries may be recharged during flight via solar energy collecting cells. Each propeller is lightweight, in an embodiment the propellers each weigh less than one kilogram and are greater than 2 metres in length. The propellers are shaped for high altitude, low speed flight. The payload of the vehicle is also carried mainly within the wing structure.

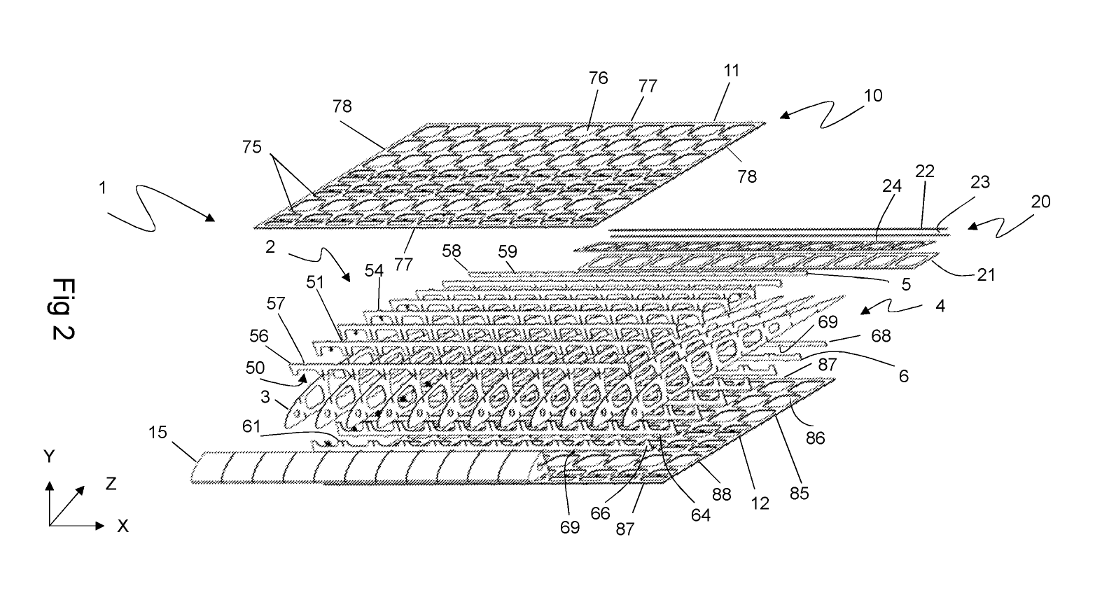

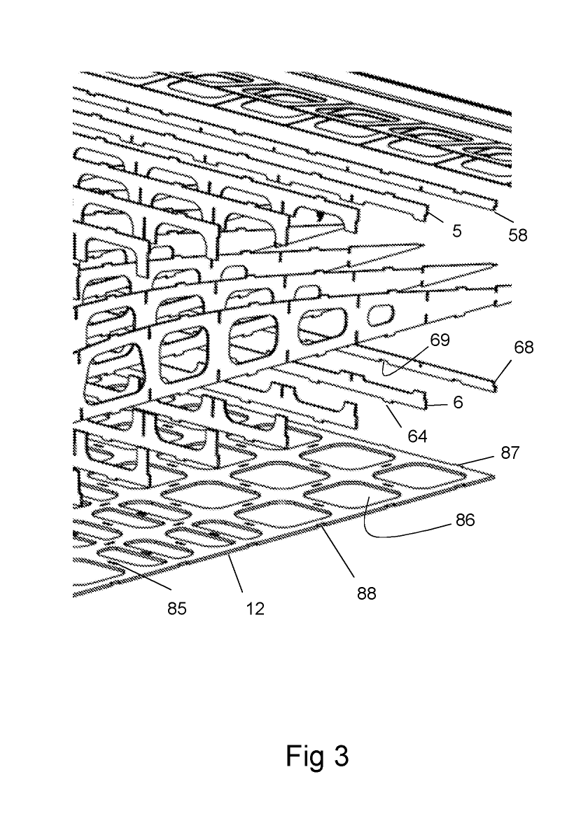

In an embodiment, each wing 101 comprises an aerofoil 1 as shown in the exploded perspective view of FIG. 2. The aerofoil 1 comprises a space frame 2 having a plurality of ribs 3 and spars 4, a cover 10 including an upper cover (skin) 11 and a lower cover (skin) 12, a leading edge assembly, a trailing edge assembly 20, and also includes an aerodynamic surface membrane (not shown in FIG. 2). The aerofoil has a cambered, low speed profile with a sharp leading edge radius. FIG. 3 provides an enlarged view of a section of the aerofoil of FIG. 2.

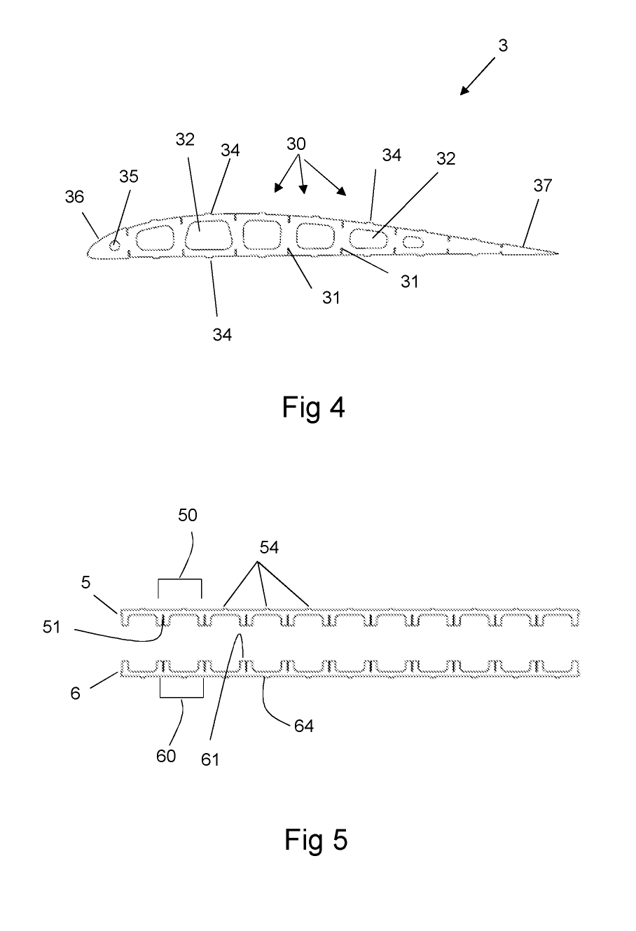

The ribs 3 extend chordwise across the aerofoil 1, and are spaced equidistantly apart in a spanwise direction. Each rib 3 is of similar overall shape and dimension. FIG. 4 shows an individual rib. The rib 3 is divided into sections 30 along its length by rib slots 31. In this embodiment the sections are spaced equidistantly apart along the length of the rib 3, however the sections 30 may vary in size according to, for example, the dimensions of the payload carried within the aerofoil.

Each section 30 has a rib slot 31 at each corner, there being per section 30 two rib slots 31 on the upper face of the rib 3 and two rib slots 31 on the lower face of the rib 3. Each section 30 is defined by the distance in a chordwise direction between two rib slots 31, and in a direction perpendicular to the spanwise and chordwise directions, i.e. vertically, by the distance between each rib slot 31 on the upper face of the rib and a corresponding rib slot 31 located vertically in line on the lower rib face. Each slot extends substantially vertically from the outer edge of the rib towards the centre of the rib. A contoured cut-out 32 is arranged in the central area of the section 30, the shape of each cut-out 32 varying as the dimensions of the sections change along the length of the rib, being substantially rectangular with curved corners. The section nearest the trailing edge has no cut-out. In other embodiments, each cut-out 32 may be any shape and may vary along the rib 3, indeed some sections may not have any cut-out.

A protruding tab 34 located in the same plane as the rib 3 lies part way along each section 30, in between the rib slots 31. Both the upper and lower edges of each rib 3 have tabs 34 in each section, with the exception of the leading edge section 36 and the trailing edge section 37. Each tab 34 interconnects with a corresponding slot in the upper cover 11 and lower cover 12, in order to locate the covers in place. Since the cover does not extend as far as the leading edge section 36 and trailing edge section 37, there is no requirement for tabs in these sections.

At the leading edge, the rib 3 has a hole 35 enabling assembly of the foam blocks 15, which form the leading edge assembly. At the trailing edge, the rib converges to a point, the aftmost rib section being trailing edge section 37, which extends to the point and acts to support the trailing edge assembly (discussed below).

Returning to FIGS. 2 and 3, each spar 4 extends spanwise along the length of the aerofoil 1 and comprises an upper spar section 5 and a lower spar section 6. FIG. 5 shows a side view of an example upper spar section 5 and lower spar section 6, aligned vertically in relation to each other. The upper spar section 5 is divided into upper segments 50, each segment defined by the distance between two upper spar slots 51. The upper spar slots 51 extend substantially vertically from the lower edge of the upper spar section 5 partway into the upper spar section 5.

The lower spar section 6 is likewise divided into lower segments 60, each segment defined by the distance between two lower spar slots 61. The lower spar slots 61 extend substantially vertically from the upper edge of the lower spar section 6 partway into the lower spar section 6.

The location of the upper spar slots 51 and the lower spar slots 61 corresponds with the rib slots 31, such that the upper spar slots 51 and the lower spar slots 61 interconnect with the rib slots 31 as part of assembling the space frame 2. The upper spar slots 51 and the lower spar slots 61 sit vertically in line with each other such that, when assembled, each rib and each spar is located substantially vertically.

When assembled, the upper spar section 5 fits flush with the upper edge of the rib 3 and the lower spar section 6 fits flush with the lower edge of the rib 3. The upper 5 and lower 6 spar sections may touch or form a connection in the centre of the aerofoil. The spacing of the upper 51 and lower 61 spar slots thus dictates the spacing of the ribs apart and their location along the aerofoil in a spanwise direction.

The profile of the upper 5 and lower 6 spar sections varies chordwise across the aerofoil 1 according to the shape of the aerofoil, the upper 5 and lower 6 spar sections having a larger vertical cross-section at the quarter chord position.

With the exception of the upper spar section 56 nearest the leading edge and the upper spar section 58 nearest the trailing edge, the upper spar sections 5 also have upper tabs 54 at an intermediate point between adjacent upper spar slots 51. These upper tabs 54 locate into upper cover slots 75 in the upper cover 11.

Similarly, and with the exception of the lower spar nearest the leading edge 56 and the lower spar nearest the trailing edge 58, the lower spar sections 6 also have lower tabs 64 at an intermediate point between adjacent lower spar slots 61. These lower tabs 64 locate into lower cover slots 85 in the lower cover 12.

The spar nearest the leading edge, comprising of upper spar section 56 and lower spar section 66, has no tabs. The upper edge of the upper spar section 56 has recesses 57, which correspond with the tabs 77 on the outer edge of the upper cover 11 at the leading edge in order to form a joint and thus assemble the upper cover 11 to the space frame. The lower edge of the lower spar section 66 has recesses 69, which correspond with the tabs 87 on the outer edge of the lower cover 12 at the leading edge in order to form a joint and thus assemble the lower cover 12 to the space frame.

The spar nearest the trailing edge, comprising of upper spar section 58 and lower spar section 68, also has no tabs. The upper edge of the upper spar section 58 has recesses 59 at an intermediate point between adjacent upper spar slots 51. The recesses 69 correspond with the tabs 77 on the outer edge of the upper cover 11 at the trailing edge. The lower edge of the lower spar section 68 has recesses 69 at an intermediate point between adjacent lower spar slots 61. The recesses 69 correspond with the tabs 87 on the outer edge of the lower cover 12 at the trailing edge. In this embodiment, the recesses 59 and 69 in the spar slots at the leading and trailing edge are at the midpoint between adjacent slots 51 or 61, however in alternative embodiments, the recesses 69 could be located at any point along the length of the spar which corresponds to slots in the upper 11 and lower 12 covers to form a joint. Additionally, components with recesses could have tabs instead and vice versa to form the joint, it does not matter which component includes tabs or recesses, only that corresponding components include one recess and one tab in order to form a joint.

The dimensions of the slots depend on location and dimensions of the relevant rib or spar. One half spar, for example is 60 mm deep with a 22 mm slot matching a 38 mm slot in the rib, but another is only 14 mm deep with a 5 mm slot. The dimensions of the tabs and recesses are about 20 mm wide, with a height or depth matched to the thickness of the Rohacell™ material sheet into which they attach. For example, the ribs, spars and cover have a material thickness of the order of 4 mm, and the trailing edge assembly has a 2 mm material thickness, but the material thickness may be thinner, for example 2 mm or 3 mm, or could also be thicker than 4 mm

Similar to the ribs, each upper 50 and lower 60 spar segments include a contoured cut-out, each upper and lower spar section describing a shape representing half of the cut-out, such that when the spar sections are fitted to the rib 3, they come together to form a complete contoured cut-out similar to those found in the ribs 3. The shape of the cut-out in the spars 4 is consistent in a spanwise direction, forming a substantially rectangular shape with curved corners.

The space frame 2 is assembled by inserting the first lower spar slot 61 of the first lower spar 6 into the rib slots 31 along the lower edge of the first rib 3, and then repeating the process for all subsequent ribs 3. In this manner, the space frame 2 is built. The slotted joints are fully slotted such that the upper and lower surfaces of the ribs and spars are flush at each node. In this embodiment the joints so formed between spar and rib sections are not bonded in order to minimise weight wherever possible, however in an alternative embodiment the some or all joints may be bonded to provide additional joint security.

The ribs 3 and upper 5 and lower 6 spar sections are formed by cutting the rib or spar profile from a sheet of structural foam. The material thickness is of the order of 4 mm, but may be thinner for example 2 mm or 3 mm, or could also be thicker than 4 mm. In this embodiment, the ribs and spar sections are cut from structural foam material of the same thickness, alternative embodiments may have specific ribs and/or spars of a differing material thickness. The structural foam used is Rohacell™ 31 IG-F although there are a number of structural foam types suitable for use, as long as the key features of lightweight combined with rigidity are present. Rohacell™ 31 IG-F is the lightest grade of structural foam currently available, with the finest cell structure. Other products with an equivalent density have a coarser cell structure and surfaces are therefore not as suitable for bonding. Heavier grades of structural foam would provide an increased stiffness, but at an increased weight.

The cover 10 includes an upper 11 and a lower cover 12, each comprising a sheet of structural foam of the same material thickness as the ribs 3 and spars 4, although in alternative embodiments the material thickness may differ. The upper cover 11 extends to cover the upper surface of the space frame 2 between the outermost ribs in a spanwise direction and the spars located at the leading edge and trailing edge in a chordwise direction. The upper cover 11 does not extend over the leading edge section 36 or the trailing edge section 37 of each rib 3. The upper cover 11 has upper cover slots 75 into which the upper tabs 54 of the upper spars 5 and the tabs 34 on the upper face of the ribs 3 locate. The upper cover slots 75 are therefore located spanwise at positions corresponding to spar 4 positions and at intervals corresponding to upper spar tab 54 positions. Additionally, upper cover slots are located in a chordwise direction across the aerofoil at positions corresponding to the location of the ribs 3 and at intervals corresponding to rib tab 34 positions on the upper face of each rib 3. For the present embodiment, the upper cover slot configuration forms rows of slots chordwise and spanwise which are substantially perpendicular to each other.

In between the various slot positions, the upper cover 11 has upper cover cut-outs 76, which when the cover is assembled to the space frame 2 locate between the rib 3 and spar 4 positions. In this embodiment, the upper cover cut-outs 76 are substantially rectangular with curved corners, however the shape of the upper cover cut-outs 76 may vary in alternative embodiments.

In the spanwise direction, the upper cover 11 has upper cover tabs 77 spaced along the outer edge of the sheet at the leading edge and trailing edge. The upper cover tabs 77 at the leading edge locate into upper spar recesses 57 on the upper spar section 56 nearest the leading edge. At the trailing edge, the upper cover tabs 77 locate into recesses 59 in the upper spar section 58 nearest the trailing edge, in order to locate the edges of the upper cover 11 to the space frame 2.

In the chordwise direction, the upper cover 11 has recesses 78 spaced along the edges of the sheet at the inboard end and at the wingtip end. The recesses 78 are spaced at intervals corresponding to the tabs 34 on the upper edge of the outermost ribs 3 at the inboard end and at the wingtip end, such that they connect as part of the assembly of the upper cover 11 to the space frame 2.

The tab and slot joints and tab and recess joints formed as the upper cover is assembled to the space frame locate such that the tabs sit flush with the outer surface of the cover.

The lower cover 12 extends to cover the lower surface of the space frame 2 between the outermost ribs in a spanwise direction and spars located at the leading edge and trailing edge in a chordwise direction. The lower cover 12 does not extend over the leading edge section 36 or the trailing edge section 37 of each rib 3. The lower cover 12 has lower cover slots 85 into which the lower tabs 64 of the lower spars 6 and the tabs 34 on the lower face of the ribs 3 locate. The lower cover slots 85 are therefore located spanwise at positions corresponding to spar 4 positions and at intervals corresponding to lower spar tab 64 positions. Additionally, lower cover slots are located in a chordwise direction across the aerofoil at positions corresponding to the location of the ribs 3 and at intervals corresponding to rib tab 34 positions on the lower face of each rib 3. For the present embodiment, the slot configuration forms rows of slots chordwise and spanwise which are substantially perpendicular to each other.

In between the various slot positions, the lower cover 12 has lower cover cut-outs 86, which when the cover is assembled to the space frame 2 locate between the rib 3 and spar 4 positions. In this embodiment, the lower cover cut-outs 86 are substantially rectangular with curved corners, however the shape of the lower cover cut-outs 86 may vary in alternative embodiments. The cover is bonded to the space frame along the edges of ribs and spars between the tabs.

In the spanwise direction, the lower cover 12 has lower cover tabs 87 spaced along the outer edge of the sheet at the leading edge and trailing edge. The lower cover tabs 87 at the leading edge locate into lower spar recesses 69 on the lower spar section 66 nearest the leading edge. At the trailing edge, the lower cover tabs 87 locate into recesses 69 in the lower spar section 68 nearest the trailing edge, in order to locate the edges of the lower cover 12 to the space frame 2.

In the chordwise direction, the lower cover 12 has lower cover recesses 88 spaced along the edges of the sheet at the inboard end and at the outboard end nearest the wingtip. The lower cover recesses 88 are spaced at intervals corresponding to the tabs 34 on the lower edge of the outermost ribs 3 at the inboard end and at the outboard end, such that they connect as part of the assembly of the lower cover 12 to the space frame 2. The tab and slot joints and tab and recess joints formed as the lower cover is assembled to the space frame locate such that the tabs sit flush with the outer surface of the cover.

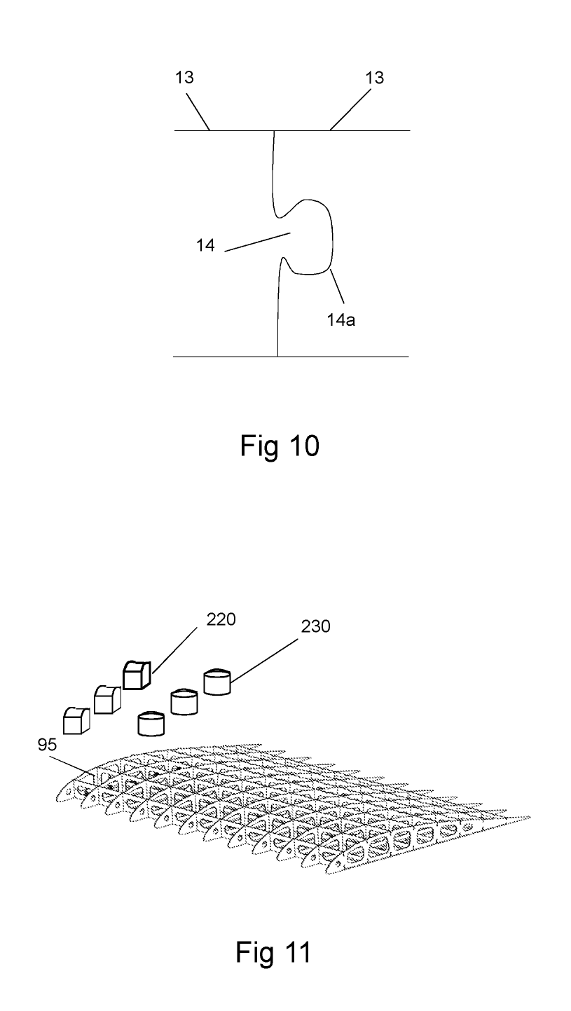

In an alternative embodiment of the upper and lower cover shown in FIG. 10, each cover is formed of a plurality of sections 13 for ease of assembly and handling. Adjoining sections 13 connect together via a plurality of interlocking planar tabs and recesses. The edge of one section has protruding planar tabs 14 which interconnect with corresponding recesses 14a in the edge of the adjoining section, similar to the manner in which a jigsaw is assembled.

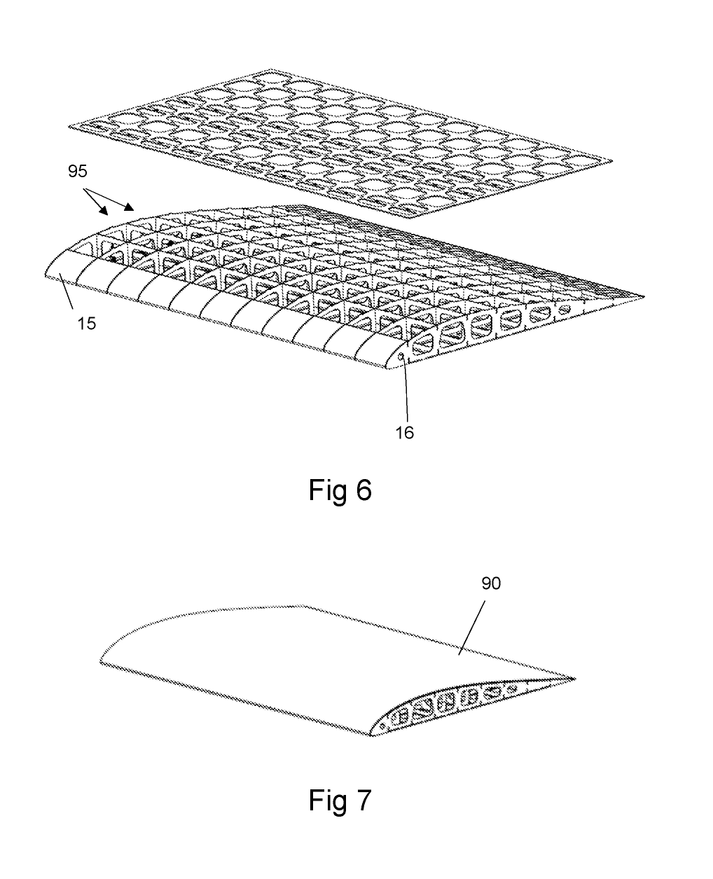

Returning to FIG. 6, with both upper cover 11 and lower cover 12 assembled on to the space frame, the aerofoil structure comprises multiple hollow cells formed by adjacent ribs 3, spars 4 and upper 11 and lower 12 covers. Each hollow cell 95 is bounded by two adjacent rib sections 30, two sets of adjacent upper 50 and lower 60 spar segments assembled together and an individual upper cover cut-out 76 and lower cover cut-out 86. In alternative arrangements, perhaps with fewer ribs and/or spars, there could be fewer hollow cells as a result; and in the extreme where the aerofoil is formed via a single spar at the leading edge and a single spar at the trailing edge together with a single rib at the inboard edge and a single rib at the wingtip, there could be a single hollow cell.

The leading edge assembly in FIG. 6 comprises a number of foam blocks 15 located at the leading edge of the aerofoil. Each foam block 15 fits into the space in between adjacent front rib sections 36. The foam blocks 15 are shaped according to the aerodynamic requirements of the leading edge, such that when assembled the foam blocks fit flush with the rib sections 36. The foam blocks 15 may be solid, or may be of hollow construction. The foam blocks 15 are expanded polystyrene but could equally be Rohacell 31 IG-F structural foam, or any alternative foam material. The foam blocks may also be designed to span more than one front rib section 36. Alternatively, the space at the leading edge and the holes 35 could be used for locating payload, for example supporting and insulating the batteries. A 30 mm diameter carbon fibre tube (not shown) passes through the holes 35 in each rib section 36 and through the bore 16 in each foam block 15 to locate the leading edge in place on the aerofoil. Alternatively, the carbon fibre tube may be omitted or only present through the sections nearest the fuselage.

The trailing edge assembly 20 comprises two strips 21 of structural foam carefully lined up with the rib edges and bonded in place. Alternatively, the two strips 21 of structural foam could be a single folded strip or individual squares of structural foam. One strip 21 of structural foam extends from the upper spar section 58 nearest the trailing edge to the tip of the trailing edge, with a further strip extending backwards over the lower surface of the final rib section 37 to the lower spar section 68. Two lengths 22, 23 of balsa wood are bonded in place using the tip of the trailing edge as a guide and are also carefully kept in line with the aforementioned squares 21, shown in the exploded view of FIG. 1.

Similarly to the upper 11 and lower 12 covers, the folding strip comprises trailing edge cut-outs 24 which are located between the rib positions 3, the upper 58 and lower 68 spar sections nearest the trailing edge, and the trailing edge. In this embodiment, the trailing edge cut-outs 24 are substantially rectangular with curved corners, however the shape of the trailing edge cut-outs 24 may vary in alternative embodiments.

The strips 21 are made from a structural foam similar to the ribs and spars, i.e. Rohacell 31 IG-F. In this embodiment, the structural foam is of a 2 mm thick Rohacell sheet, which is thinner material thickness than the structural foam used for the ribs, spars and cover. In alternative embodiments, the structural foam used could be thicker, thinner or the same thickness as that used for other components of the aerofoil, or indeed the trailing edge could be made of an alternative lightweight material such as balsa wood, plastic or composite. Equally, the upper cover 11 and lower cover 12 could be extended all the way to the trailing edge, replacing the need for individual squares or separate strips 21 of structural foam at the trailing edge. In a further embodiment, the individual strips 21 or squares have similar tabs and recesses as shown on the upper 11 and lower 12 covers.

FIG. 7 shows the assembled aerofoil including the aerodynamic surface membrane 90. The membrane is pre-stressed and then stretched over the aerofoil and taped on to the aerofoil. This enables the aerofoil to behave as a monocoque structure, i.e. the membrane becomes a structural component also and increases the loads that can be supported by the aerofoil. The membrane may be of any lightweight material that is dimensionally stable both with temperature and under UV light conditions, whilst providing good tensile strength to weight ratio. In this embodiment, a polyimide film such as Kapton™ is used, with a thickness of 12.5 micron. Alternatives include Mylar film.

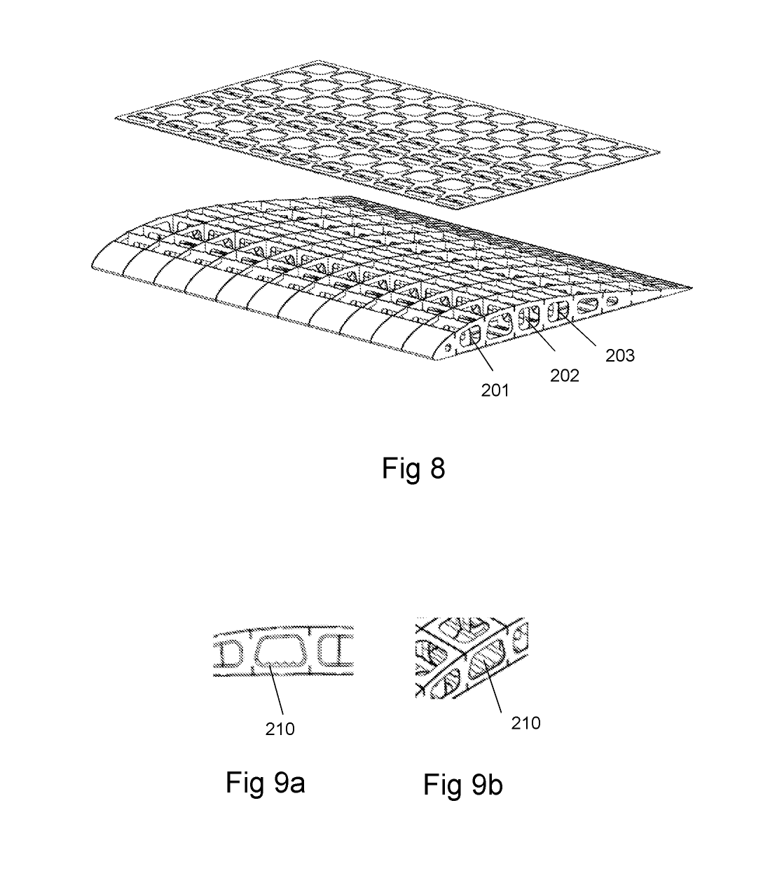

The payload is carried inside the hollow sections 95, typically along successive hollow sections formed at the quarter chord position, where the hollow sections have the largest dimensions. Optionally, as shown in FIG. 8, one or more additional reinforcing spars 201, 202, 203 can be located either side of the hollow cells carrying the payload. These additional spars 201, 202, 203 are fed in through one end of the assembled space frame 2 and twisted into position. Optionally, the lower face of the hollow cells carrying payload are also reinforced and shaped so as to facilitate location of items or cables within the cell, see 210 in FIGS. 9a and 9b.

In an alternative embodiment, the upper and lower foam covers are omitted, and double sided solar cells 220, 230 form the cover, as shown schematically in FIG. 11. The solar cells 220, 230 may be of any convenient shape, for example substantially square 220 or tubular 230, and may have profiled surfaces so as to fit into the hollow cells 95 of the space frame, follow the curvature of the aerofoil surface and form the upper and lower covering of the aerofoil. Alternatively, two solar cells could be assembled to form a double sided solar cell. A double sided solar cell may not be significantly thicker than a single sided solar cell (although the solar cell arrangement could be assembled double sided rather than made double sided). The solar cells 220, 230 are then mounted within the cells under a transparent cover and membrane 90. Alternatively, the solar cells 220, 230 may be integrated into the top skin. A similar arrangement of solar cells 220, 230 may be included in the tailplane 103.

Although the invention has been described above with reference to one or more preferred embodiments, it will be appreciated that various changes or modifications may be made without departing from the scope of the invention as defined in the appended claims.

What is claimed is:

1: An aerofoil comprising at least one space frame and at least one cover supported by the space frame, wherein the space frame has one or more structural members, the structural members including a structural foam material; and the cover includes a pre-stressed membrane which forms at least a part of an external aerodynamic surface of the aerofoil.

2: An aerofoil according to claim 1 wherein the structural member(s) consist of a structural foam material.

3: An aerofoil according to claim 1, wherein the structural foam material of the structural member includes at least one cut-out.

4: An aerofoil according to claim 1, wherein the cover includes a structural foam material.

5: An aerofoil according to claim 4, wherein the structural foam material of the cover includes at least one cut-out.

6: An aerofoil according to claim 1, wherein the aerofoil includes one or more hollow cells bounded by the space frame and the cover.

7: An aerofoil according to claim 6, wherein one or more of the hollow cells extend spanwise along the aerofoil and carries payload.

8: An aerofoil according to claim 1, wherein the structural foam material is a cellular core foam of for example polystyrene, polycarbonate, polyvinylchloride, polypropylene, acrylonitrile-butadiene-styrene or a polymethacrylimide (PMI) foam such as Rohacell™.

9: An aerofoil according to claim 1, wherein the space frame comprises one or more chordwise ribs and one or more longitudinal spars.

10: An aerofoil according to claim 9, wherein one or more of the spars includes structural foam material.

11: An aerofoil according to claim 10, wherein the one or more spars are formed in two or more parts and connect with the one or more ribs.

12: An aerofoil according to claim 9, wherein one or more of the ribs includes structural foam material.

13: An aerofoil according to claim 9, wherein one or more of the ribs and/or spars is substantially planar.

14: An aerofoil according to claim 9, wherein the aerofoil comprises a plurality of spars spaced apart in the chordwise direction, the distance between adjacent spars being the spar pitch, wherein the spar pitch is irregular in the chordwise direction.

15: An aerofoil according to claim 1, wherein one or more joints are formed between structural members, wherein each structural member comprises one or more cooperative connecting features such that each joint is formed by connecting the cooperative connecting feature(s) of one structural member with the corresponding cooperative connecting feature(s) of a further structural member.

16: An unmanned aerial vehicle comprising the aerofoil of claim 1.

17: An unmanned aerial vehicle according to claim 16, wherein the unmanned aerial vehicle has a wingspan of from 20 m to 60 m.

18: An unmanned aerial vehicle according to claim 16, further comprising at least two wings, a fuselage, a tail and at least one propeller powered by a motor and a power supply.

19: A method of producing an aerofoil comprising at least one space frame and at least one cover supported by the space frame comprising the steps of:
forming a space frame comprising one or more structural members, the structural members including a structural foam material;
pre-stressing and attaching a membrane, which forms at least part of the cover, to the space frame.

20: A method of producing an aerofoil according to claim 19, wherein the step of forming the space frame includes assembling at least two structural members, the assembly step comprises forming one or more joints between members, wherein each structural member comprises one or more cooperative connecting features such that each joint is formed by connecting the cooperative connecting feature(s) of one structural member with the corresponding cooperative connecting feature(s) of a further structural member.

21: A method of producing an aerofoil according to claim 19, wherein one or more parts of the space frame is formed from one or more blocks of structural foam with structural members formed by removing material from the foam block.

22: An aerofoil according to claim 1, wherein the membrane is a film material.

23: A method of producing an aerofoil according to claim 19, wherein the membrane is attached to the space frame and then pre-stressed.

24: A method of producing an aerofoil according to claim 19, wherein the membrane is a film material.
